(19) United States
(12) Patent Application Publication
(10) Pub. No.: US 2011/0087691 A1
(43) Pub. Date: Apr. 14, 2011

(54) MOBILE DEVICE AND METHOD FOR SUPPORTING SEARCH FOR END-USER FUNCTIONS

(75) Inventor: Jong Ho HAN, Yongin-si (KR)

(73) Assignee: SAMSUNG ELECTRONICS CO. LTD., Suwon-si (KR)

(21) Appl. No.: 12/898,080

(22) Filed: Oct. 5, 2010

(30) Foreign Application Priority Data
Oct. 9, 2009 (KR) 10-2009-0096037

(51) Int. Cl. G06F 17/30

(52) U.S. Cl. 707/769; 707/E17.014

(57) ABSTRACT

A mobile device and method for supporting an easy, quick, and exact search for end-user functions by allowing a user to directly input a search word related to a desired end-user function are provided. The mobile device offers a search environment and receives a search word including at least one of letters and numerals from an input unit through the environment. Then the mobile device performs a search based on at least one of a synonym, an acronym and a category of function names by finding at least one of the synonym, acronym and category containing the search word. Thereafter, the mobile device outputs at least one of the function names as search results on a display unit.

### PRIORITY

This application claims the benefit under 35 U.S.C. §119(a) of a Korean patent application filed on Oct. 9, 2009 in the Korean Intellectual Property Office and assigned Serial No. 10-2009-0096037, the entire disclosure of which is hereby incorporated by reference.

### BACKGROUND OF THE INVENTION

1. Field of the Invention

The present invention relates to a mobile device. More particularly, the present invention relates to a mobile device and method for supporting an easy, quick, and exact search for end-user functions.

2. Description of the Related Art

As known in the art, a mobile device refers to a kind of electronic device that includes mobility as a primary feature. With the remarkable growth of related technologies, a great variety of mobile devices capable of supporting various end-user functions are becoming increasingly popular. Meanwhile, many types of input devices are used for the mobile device to offer end-user functions. For instance, a conventional mobile device may employ a traditional keypad layout that includes physical keys that occupy a considerable part of the exterior of the mobile device. Recently, in order to obtain a much larger display while staying within the size constraints of the mobile device, the area traditionally used for the keypad is additionally used for the display in the form of a touch screen.

Nowadays, such a mobile device offers various end-user functions for enhancing a user's convenience. However, there are cases in which a user fails to use a desired one of many end-user functions. In other words, since a user may not know of all of the end-user functions installed in the mobile device, he or she may have difficulty in verifying whether a specific desired function is available or not. In this case, if a user wants to verify availability of all of the end-user functions installed in the mobile device, the user should look through a manual of the mobile device or browse through menus of the mobile device one by one, thereby causing inconvenience to the user.

### SUMMARY OF THE INVENTION

An aspect of the present invention is to address at least the above-mentioned problems and/or disadvantages and to provide at least the advantages described below. Accordingly, an aspect of the present invention is to provide a mobile device and method for supporting an easy, quick, and exact search for end-user functions by allowing a user to directly input a search word related to a desired end-user function.

In accordance with an aspect of the present invention, a method for supporting a search for end-user functions in a mobile device is provided. The method includes receiving a search word including at least one of letters and numerals from an input unit, performing a search based on at least one of a synonym, an acronym and a category of function names by finding at least one of the synonym, the acronym and the category containing the search word, and outputting at least one of the function names as search results on a display unit.

In accordance with another aspect of the present invention, a mobile device for supporting a search for end-user functions is provided. The mobile device includes an input unit configured to create a search word including at least one of letters and numerals, a control unit configured to perform a search based on at least one of a synonym, an acronym and a category of function names by finding at least one of the synonym, the acronym and the category containing the search word, and a display unit configured to output at least one of the function names as search results.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flow diagram illustrating a method for supporting a search for end-user functions in a mobile device according to an exemplary embodiment of the present invention.

FIG. 2 is a view illustrating an example of an end-user function table based on at least one of a synonym, an acronym and a category according to an exemplary embodiment of the present invention.

FIG. 3 is a view illustrating an example of a screen interface used for supporting a search for end-user functions according to an exemplary embodiment of the present invention.

FIG. 4 is a view illustrating another example of a screen interface used for supporting a search for end-user functions according to an exemplary embodiment of the present invention.

FIG. 5 is a block diagram illustrating the configuration of a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to exemplary embodiments of the present invention, when a user selects a function search mode, the mobile device offers a search environment on a display unit. Once a search word is received based on an input from a user, the mobile device performs a search based on at least one of a synonym, an acronym and a category of a function name and then outputs candidates for a specific end-user function as search results on the display unit in response to the received search word. Therefore, a user can easily find a desired end-user function among candidates on the display unit. Meanwhile, among terms set forth herein, the term “function name” refers to the name of each end-user function available for the mobile device. Now, a method for supporting a search for end-user functions will be described in more detail below.

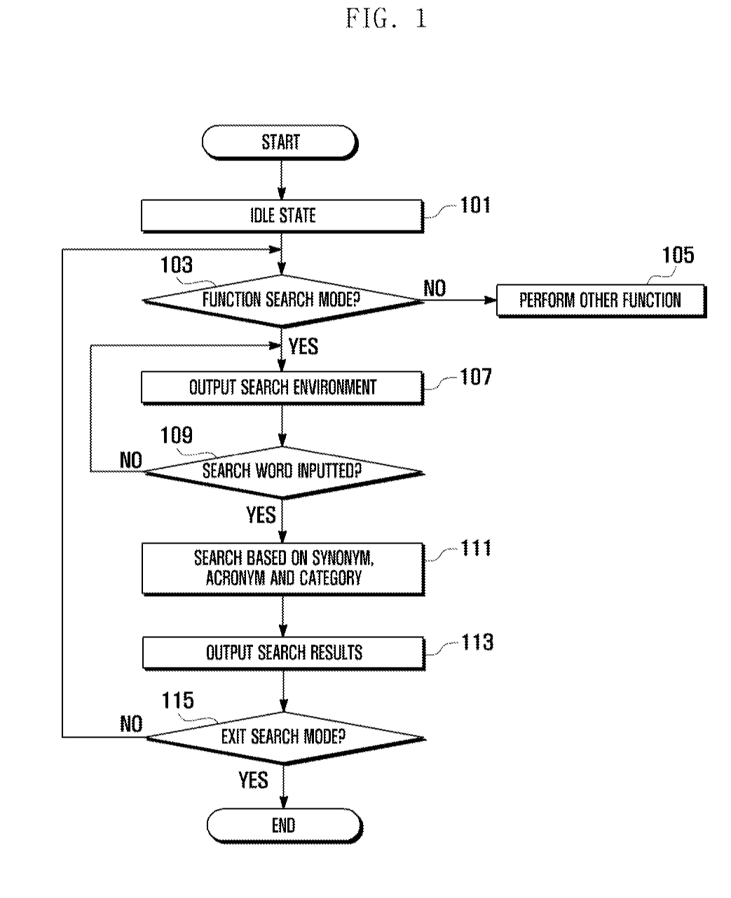

FIG. 1 is a flow diagram illustrating a method for supporting a search for end-user functions in a mobile device according to an exemplary embodiment of the present invention.

Referring to FIG. 1, after power is supplied, the mobile device initializes respective elements and then outputs a predefined idle screen according to a given schedule in step 101. Although not shown, if there is no input signal for a given time during step 101, the mobile device may enter a sleep mode. Thereafter, if there is any input signal, the mobile device may output the idle screen or a specific screen offered by a particular application that has been executed just before entering the sleep mode.

Next, if a certain input signal is received, the mobile device determines whether to enter a function search mode in response to the received input signal in step 103. Here, the mobile device may offer a menu item for entering into the function search mode and, when receiving an input signal for selecting the above menu item, will enter the function search mode. Alternatively, if there is a particular hot key or shortcut key for directly entering into the function search mode, the mobile device will enter the function search mode in response to an input signal from the hot key or shortcut key. Meanwhile, if the received input signal is not a signal for entering into the function search mode, the mobile device may perform another end-user function in response to the received input signal in step 105. For instance, the mobile device may perform one of a mobile communication function, a camera function, a file play function, a recording function, a game function, etc., depending on the received input signal.

If the received input signal is for entering into the function search mode, the mobile device builds and outputs a search environment that supports a search for end-user functions in step 107. Namely, the mobile device may create and offer an input window for receiving a search word and an output window for showing search results on a display unit so that a user can input a search word and also check the results from the function search.

Thereafter, the mobile device determines whether a search word is inputted in step 109. Namely, the mobile device determines whether there is an input signal indicating at least one of letters, numerals and special characters, and if the mobile device determines that there is an input signal related to a search word, the mobile device outputs the inputted letter, etc. on the input window for a search word. If an input signal is not related to a search word, namely if an input signal includes instructions to exit the function search mode or to resume any other previous step, the mobile device closes the search environment and returns to the previous step 107.

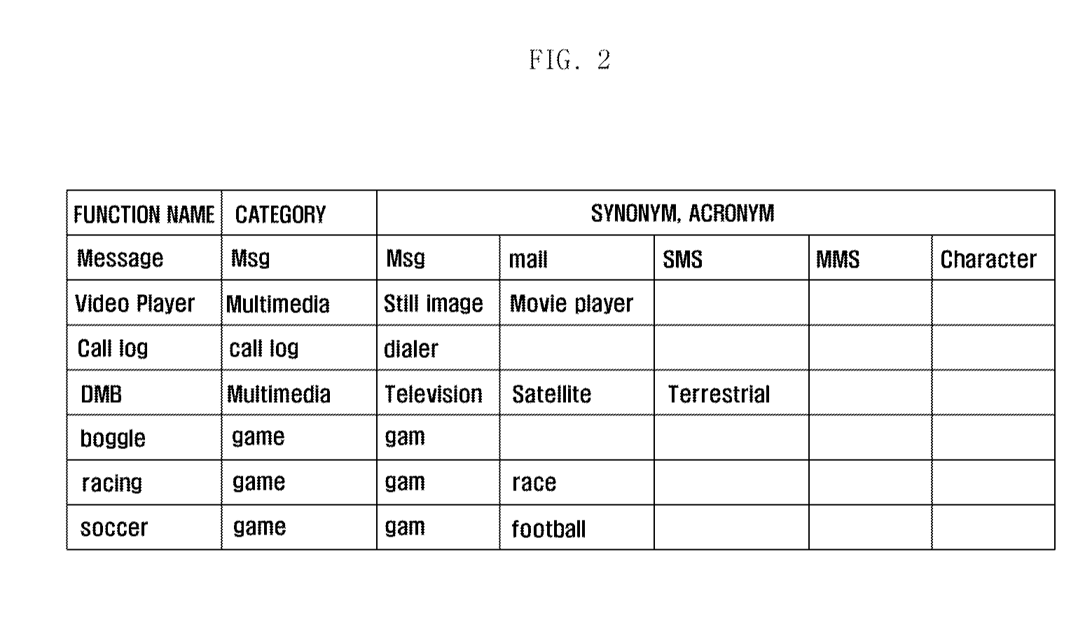

If a certain search word is inputted by a user, the mobile device performs a search for end-user functions, based on at least one of a synonym, an acronym and a category of a function name in step 111, and outputs the search results in response to the inputted search word in step 113. More specifically, when a user inputs a search word ‘play’, the mobile device may search end-user functions related to the search word ‘play’ and outputs function names found during the search on the output window. For instance, if end-user functions related to the search word ‘play’ contain a music file play function, a movie file play function, and a photo slide play function, the mobile device finds the above functions through a search process based on at least one of a synonym, an acronym and a category of a function name and outputs the search results on the output window. A search technique based on at least one of a synonym, an acronym and a category will be described in more detail further below with reference to FIG. 2.

The mobile device determines whether to exit the function search mode in step 115. If the mobile device determines not to exit the function search mode, the mobile device closes the search environment for a function search and returns to the previous step 103. Meanwhile, if a user selects one of end-user functions outputted as search results on the output window before step 115, the mobile device may activate and perform the corresponding selected function. For instance, if a user selects a music file play function, the mobile device may activate a music player and then output a file list in order for a user to select a music file.

As discussed heretofore, in the method according to exemplary embodiments of the present invention, the mobile device performs a search based on at least one of a synonym, an acronym and a category to find a specific end-user function in response to an inputted search word, and offers candidate end-user functions as the search results on the display unit. Therefore, a user can easily find a desired end-user function among candidate end-user functions on the display unit.

FIG. 2 is a view illustrating an example of an end-user function table based on at least one of a synonym, an acronym and a category according to an exemplary embodiment of the present invention.

Referring to FIG. 2, the end-user function table is designed to contain a function name field, a category field, and a synonym/acronym field. Specifically, the function name field is to record the name of each end-user function provided by the mobile device. As shown in FIG. 2, items recorded in the function name field may include a message function, a video player function, a call log function, a Digital Multimedia Broadcasting (DMB) function, a Boggle™ game function, a racing game function, a soccer game function, etc., for example. The category field is to record the category of each end-user function. For example, items recorded in the category field may be “msg” for a message function, “multimedia” for a video player function and a DMB function, “call log” for a call log function, and “game” for a Boggle™ game function, a racing game function and a soccer game function. The synonym/acronym field is to record at least one of the synonym and acronym of each function name. For example, items recorded in the synonym/acronym field may be “msg, mail, a Short Message Service (SMS), a Multimedia Messaging Service (MMS), and character” for a message function, “still image and movie player” for a video player function, “dialer” for a call log function, “television, satellite, and terrestrial” for a DMB function, “gam” for a Boggle™ game function, “gam and race” for a racing game function, and “gam and football” for a soccer game function.

The mobile device allows an update of the end-user function table, namely the mobile device allows for at least one of modifying, adding and deleting items in respective fields of the end-user function table. Specifically, the mobile device may offer a specific menu suitable for performing an update of the end-user function table. When this update menu is activated by a user, the mobile device may access the mobile communication system and perform a process of updating the end-user function table. The manufacturer of the mobile device may produce update information used for an update of the end-user function table. In addition, the manufacturer may construct a server that can send the update information to the mobile device through a message service or web service when accessed by the mobile device. Therefore, the mobile device can update the end-user function table by accessing the server and receiving the update information. Meanwhile, the mobile device may offer a table edit mode for manually editing the end-user function table and may further offer a table editor executable in the table edit mode. In this case, the mobile device may output the end-user function table, as shown in FIG. 2, on the display unit. A user may directly edit items recorded in the category field and the synonym/acronym field.

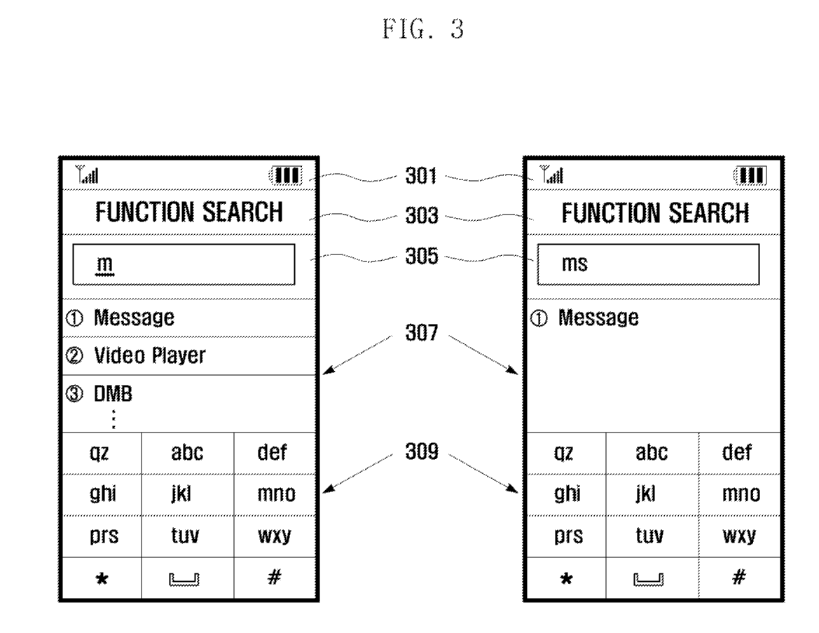

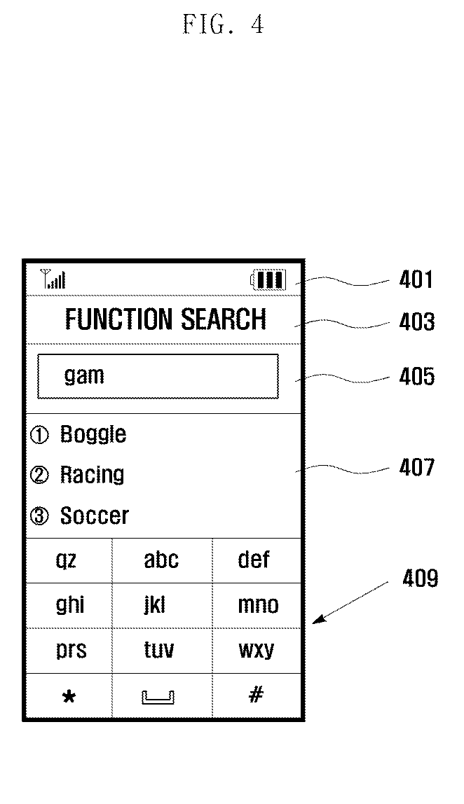

As discussed heretofore, the mobile device according to exemplary embodiments of the present invention may find the end-user functions based on at least one of a category, a synonym and an acronym, when at least one of which is identical to the inputted search word, and may output the found end-user functions on the display unit. Now, a screen interface adapted to a function search will be described in more detail with reference to FIGS. 3 and 4.

FIG. 3 is a view illustrating an example of a screen interface used for supporting a search for end-user functions according to an exemplary embodiment of the present invention. As discussed above, a user can use at least one of a menu item and hot key in order for the mobile device to enter a function search mode. In the function search mode, the mobile device outputs a search environment for a function search on a display unit.

Referring to FIG. 3, the mobile device builds and provides a screen interface as a search environment suitable for a function search. As respectively shown in left and right screens in FIG. 3, the screen interface includes an indicator region 301, a title region 303, an input window 305, an output window 307, and a virtual keypad 309. A user can input a search word into the input window 305 by using the virtual keypad 309.

The indicator region 301 offers basic information about states of the mobile device. For instance, the indicator region 301 may represent an icon indicating the strength of a received signal, an icon indicating a battery level, and the like. In particular, the indicator region 301 may output a specific icon indicating that a function search mode is enabled. This icon may, however, be omitted according to user's setting or a design scheme.

The title region 303 offers the title of a particular end-user function that is running. For instance, if the function of a function search is activated, namely if the mobile device enters a function search mode, the title region 303 may output a given title ‘Function Search’.

The input window 305 represents a search word inputted by a user through the virtual keypad 309. For instance, if a user inputs the letter “m” by selecting a corresponding key on the virtual keypad 309, the input window 305 outputs the inputted letter “m”. In addition, the input window 305 may also represent a kind of text cursor indicating where a letter will be placed when entered.

The output window 307 outputs the search results in response to a search word inputted into the input window 305. Namely, when a certain search word is inputted, the mobile device finds a specific at least one of a category, a synonym and an acronym containing the inputted search word and offers the name of end-user functions corresponding to the found results via the output window 307. For instance, if the letter “m” is inputted into the input window 305, the mobile device finds end-user functions containing the letter “m” in at least one of their category, their synonym and their acronym and outputs the results on the output window 307. In an example of FIG. 2, three end-user functions, namely “message, video player, and DMB” contain the letter “m” within at least one of a category, a synonym and an acronym. Therefore, the output window 307 outputs end-user functions “message”, “video player” and “DMB” as the search results.

The virtual keypad 309 offers the arrangement of virtual keys that receive and react to a user's touch input. In another case, the virtual keypad 309 may be replaced with a physical keypad or key buttons that may be excluded from the screen interface. Normally the virtual keypad 309 creates a touch event depending on a user's touch on a specific key and determines the inputted letter, numeral or other special character by means of a letter input algorithm the mobile device uses.

As shown in the right screen in FIG. 3, a user may further input the letter “s” after inputting the letter “m”. At this time, the mobile device represents continuous letters “ms” on the input window 305 and then again finds end-user functions containing the continuous letters “ms” in at least one of their category, their synonym and their acronym. In an example of FIG. 2, the end-user function “message” only contains the letters “ms” within at least one of a category, a synonym and an acronym. The mobile device outputs the end-user function “message” as the search results on the output window 307. Therefore, a user can easily find that the end-user function “message” has been already installed in the mobile device and is available.

FIG. 4 is a view illustrating another example of a screen interface used for supporting a search for end-user functions according to an exemplary embodiment of the present invention. As discussed above, a user can use a menu item or hot key in order for the mobile device to enter a function search mode. In the function search mode, the mobile device outputs a search environment for a function search on a display unit.

Referring to FIG. 4, the mobile device builds and provides a screen interface as a search environment suitable for a function search. As discussed earlier referring to FIG. 3, the screen interface is composed of an indicator region 401, a title region 403, an input window 405, an output window 407, and a virtual keypad 409. A user can input a search word into the input window 405 by using the virtual keypad 409. Since the indicator region 401, the title region 403 and the virtual keypad 409 are the same as the indicator region 301, the title region 303 and the virtual keypad 309 discussed in FIG. 3, the indicator region 401, the title region 403 and the virtual keypad 409 will be not described herein to avoid unnecessary repetition.

As shown, if a user continuously inputs three letters “g”, “a” and “m” as a search word through the virtual keypad 409, the input window 405 outputs continuous letters “gam”. The output window 407 outputs the name of end-user functions containing the inputted search word “gam” in at least one of their category, their synonym and their acronym. Here, the mobile device may perform a function search in two different ways. First, as discussed in FIG. 3, the mobile device may perform a function search whenever each letter is inputted. In this case, the search results offered on the output window 407 may be varied whenever each letter is inputted. Second, the mobile device may perform a function search when receiving a given additional input signal such as the OK key signal after at least one letter is inputted. In this case, even though some letters are inputted, the mobile device does not perform a function search until a given input signal is inputted by the user.

In an example of FIG. 2, if letters “gam” are inputted into the input window 405, the mobile device finds three end-user functions “boggle”, “racing” and “soccer” each of which contains the letters “gam” in its category, synonym or acronym. The mobile device outputs them as the search results on the output window 407. Here, the mobile device may arrange the results according to their priority and may also endow the results with different numbers for the convenience of a user's selection. A user may select one of such numbers in the virtual keypad 409 or may directly touch one of the end-user functions on the output window 407.

As discussed heretofore, in the method according to exemplary embodiments of the present invention, the mobile device arranges end-user functions by at least one of their synonym, their acronym and their category and performs a search based on at least one of a synonym, an acronym and a category when a search word is inputted into the input window 405 by a user. The mobile device outputs candidate end-user functions for a desired end-user function as the search results on the output window 407, so that a user can easily and quickly find the desired end-user function among candidate end-user functions.

Hereinbefore, the method for supporting the function search has been described together with related screen interfaces. Now, the mobile device that executes the above-discussed method will be described in more detail below.

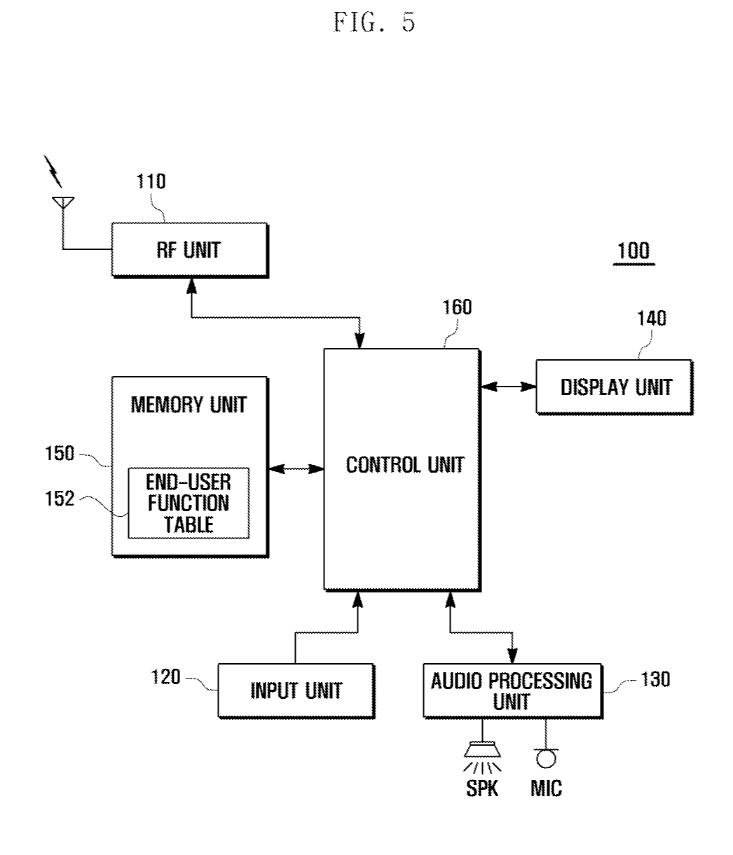

FIG. 5 is a block diagram illustrating the configuration of a mobile device according to an exemplary embodiment of the present invention.

Referring to FIG. 5, the mobile device 100 includes a Radio Frequency (RF) unit 110, an input unit 120, an audio processing unit 130, a display unit 140, a memory unit 150, and a control unit 160. More particularly, the input unit 120 may facilitate the aforesaid virtual keypad 309 and 409 in FIGS. 3 and 4. Moreover, the memory unit 150 may have an end-user function table 152 which may be the same end-user function table discussed above with respect to FIG. 2.

In short, the mobile device 100 having the above elements may receive a search word through the input unit 120 and, depending on the search word, perform a search based on at least one of a synonym, an acronym and a category of end-users functions arranged in the end-user function table 152. Additionally, the mobile device 100 may offer a function search interface on the display unit 140 and then output candidate end-user functions as the search results on the display unit 140. Furthermore, the mobile device 100 may perform an update of the end-user function table 152 by one of modifying, adding and deleting items in respective fields of the end-user function table 152. Now, each individual element of the mobile device 100 will be described in more detail.

The RF unit 110 establishes communication channels used for a voice call, data transmission, etc. under the control of the control unit 160. Namely, the RF unit 110 forms at least one of a voice call channel, a data communication channel, a video call channel, etc. with a mobile communication system. The RF unit 110 may include an RF transmitter that upwardly converts the frequency of transmitted signals and amplifies the transmitted signals, and an RF receiver that amplifies received signals with low-noise and downwardly converts the frequency of the received signals.

The RF unit 110 may support various end-user functions based on a mobile communication service of the mobile device 100. For instance, the RF unit 110 may support a voice call function, a video call function, an SMS function, an MMS function, a web access function, a file download function, and the like, based on the establishment of one or more communication channels with the mobile communication system. The above end-user functions may be recorded with at least one of their category, their synonym and their acronym in the aforesaid end-user function table 152. For instance, call functions among end-user functions may be recorded with at least one of their category, their synonym and their acronym such as “call, communication, voice, video, and image”. Also, a web access function and a file download function may be recorded with at least one of their category, their synonym and their acronym such as “web, browser, download, file, www, and Internet”. Meanwhile, the end-user function table 152 is updatable. To facilitate the updating of the end-user function table 152, the RF unit 110 may establish a communication channel with a specific server and receive update information from the server under the control of the control unit 160.

The input unit 120 may include a plurality of alphanumeric keys and/or function keys that receive a user's input action and thereby creates an input signal for controlling the mobile device 100. The function keys may have navigation keys, side keys, shortcut keys, and the like. The input unit 120 may be formed of an actual keypad that adopts one of a qwerty, a 3*4 and a 4*3 key arrangement. Additionally, if the mobile device 100 supports a touch screen, the input unit 120 may have a virtual key layout that adopts one of a qwerty key map, a 3*4 key map, a 4*3 key map, a menu map and a soft key map. More particularly, the input unit 120 creates an input signal to select a menu of a function search, an input signal to input a search word, an input signal to select one of candidates for end-user functions, etc. in response to a user's manipulation, and sends a signal corresponding to the input to the control unit 160. As discussed above, the input unit 120 may be formed of the virtual keypad 309 or 409 in FIGS. 3 and 4.

The audio processing unit 130 includes a speaker (SPK) for outputting audio data and a microphone (MIC) for collecting audio signals. The audio processing unit 130 may output signal sounds when a search word is inputted, sound effects when the search results are outputted, and sound effects when one of the candidate end-user functions is selected.

The display unit 140 represents information inputted by a user or offered to a user, including various menus of the mobile device 100. For instance, the display unit 140 may visually offer various screen views of an idle screen, a menu screen, a message writing screen, a call screen, and the like. The display unit 140 may be formed of a Liquid Crystal Display (LCD), an Organic Light Emitting Diode (OLED), or any other type of display. In case of a touch screen, the display unit 140 may further act as the input unit 120.

More particularly, the display unit 140 may offer a screen interface for a function search as a search environment. As shown in FIGS. 3 and 4, such a screen interface may include the indicator region 301 or 401, the title region 303 or 403, the input window 305 or 405, and the output window 307 or 407. In addition, depending on the type of the input unit 120, the virtual keypad 309 or 409 may be also outputted on the display unit 140. Meanwhile, if there is no search result in response to a search word inputted in the input window 305 or 405, the display unit 140 may output no function name in the output window 307 or 407. Alternatively, in such case, the display unit 140 may output a message in the form of a pop-up window, for example, “No Results Found”.

The memory unit 150 stores a variety of applications used by functions related to exemplary embodiments of the present invention. When the mobile device 100 employs a touch screen, the memory unit 150 may store a key map, a menu map, a soft key map, etc. used for the operation of a touch screen. Here, the key map may have various well known types such as a keyboard map, a 3*4 key map, a qwerty key map, or a special control key map suitable for the operation of a specific application. Also, the menu map may be a special menu map suitable for the operation of a specific application in use and may have several menu items offered by the mobile device 100. The memory unit 150 may consist of a program region and a data region.

The program region may store an Operating System (OS) for booting and operating the mobile device 100, and applications required for performing various functions of the mobile device 100, such as a call application, a web browser for surfing on the Internet, an MP3 application for playing digital sounds, an image viewer application for showing image files, a video player application, a game application, and the like.

More particularly, the program region stores a function search application which may be activated when a corresponding menu item is selected. The function search application outputs a screen interface suitable for a function search on the display unit 140 in response to an input signal for an activation request. More specifically, the function search application may contain a routine for outputting a screen interface suitable for a function search when the input unit 120 creates an input signal for an activation request, a routine for displaying a search word on the input window 305 or 405 when at least one of letters and numerals is inputted while the screen interface is outputted, a routine for performing a search for function names with reference to the end-user function table 152 stored in the memory unit 150 when a search word is inputted into the input window 305 or 405, a routine for displaying candidate user-function names as search results on the output window 307 or 407, a routine for outputting a given message when there is no search result, a routine for activating a particular function when one of candidates for function names is selected, and the like.

Furthermore, the program region may store a function table update application which may be activated when a corresponding menu item is selected. Also, the function table update application may be activated at predefined periods. Specifically, the function table update application may contain a routine for activating a web browser in response to a user's manipulation, a routine for accessing a specific server that provides update information about the end-user function table 152, a routine for receiving the update information about the end-user function table 152 from the server, and a routine for updating the end-user function table 152 by using the received update information. Alternatively or additionally, the function table update application may contain a routine for offering a screen interface suitable for a function table update in response to a user's manipulation, a routine for modifying, adding or deleting at least one of category, synonym and acronym in response to an input signal received from the input unit 120, and a routine for applying an updated routine to the end-user function table 152. Preferably, the function names may be fixed in view of compatibility and also may consist of end-user functions only available for the mobile device 100.

The data region stores data created while the mobile device 100 is used. For instance, the data region may store phonebook data, icons, contents, and the like. In addition, when the display unit 140 is formed of a touch screen, the data region may store user's inputs received from the touch screen. More particularly, the data region stores the end-user function table 152 as shown in FIG. 2. Also, if the function table update application is designed to receive update information about the end-user function table from an update server, the data region may store such update information received from the server.

The control unit 160 controls a power supply and initialization process for each element of the mobile device 100 and also controls the flow of signals for a function search according to an exemplary embodiment of the present invention. More specifically, the control unit 160 offers a menu containing a specific item for a function search when receiving a given input signal from the input unit 120, activates the function search application stored in the program region when the specific item is selected, and outputs a screen interface suitable for a function search on the display unit 140. Thereafter, when a search word is inputted into the input window 305 or 405 through the input unit 120, the control unit 160 performs a search for function names with reference to the end-user function table 152 stored in the memory unit 150 and then outputs candidate function names as search results on the output window 307 or 407. Also, when one of candidates for function names is selected, the control unit 160 activates a particular end-user function corresponding to the selected function name. Here, the control unit 160 selectively performs a control of a power supply and a control of a signal flow for elements used for supporting the activated end-user function. Meanwhile, the control unit 160 may control the operation of a web browser or of a screen interface suitable for a function table update.

As fully discussed hereinbefore, the mobile device 100 according to exemplary embodiments of the present invention offer a screen interface suitable for a function search mode when a menu item for a function search is activated, performs a search for end-user functions using at least one of their synonym, their acronym and their category, and then outputs the search results. Therefore, a user can easily and quickly find a desired end-user function available for the mobile device 100.

Meanwhile, the above-discussed search word inputted through the input unit 120 is not limited to letters and may further use numerals, symbols, and the like. Similarly, the end-user function table 152 may further use numerals, symbols, and the like as well as letters for at least one of a synonym, an acronym and a category.

Additionally, if the mobile device 100 supports a voice recognition function, the above-discussed search word may be inputted in the form of a voice. In this case, the memory unit 150 of the mobile device 100 may further include database and algorithm required for voice recognition. Also, the mobile device 100 may collect a user's voice through the microphone (MIC) of the audio processing unit 130 and then perform a voice recognition process to identify a search word.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for supporting a search for end-user functions in a mobile device, the method comprising:
receiving a search word including at least one of letters and numerals from an input unit;
performing a search based on at least one of a synonym, an acronym and a category of function names by finding at least one of the synonym, the acronym and the category containing the search word; and
outputting at least one of the function names as search results on a display unit.

2. The method of claim 1, further comprising:
receiving an input signal for entering a function search mode; and
outputting a screen interface suitable for supporting the function search mode on the display unit.

3. The method of claim 2, wherein the input signal for entering a function search mode is based on the selection of at least one of a menu item and a hot key.

4. The method of claim 1, further comprising:
outputting a given message on the display unit when there is no search result in response to the search word.

5. The method of claim 1, wherein the performing of the search includes performing the search whenever each of the letters and numerals included in the search word is inputted.

6. The method of claim 1, further comprising:
updating an end-user function table that records the function names, and at least one of the category, the synonym, and the acronym of the function names.

7. The method of claim 6, wherein the updating of the end-user function table includes:
activating a web browser;
accessing an update server through the web browser;
receiving update information from the update server; and
performing an update of the end-user function table by using the received information.

8. The method of claim 6, wherein the updating of the end-user function table includes:
outputting a screen interface suitable for the updating of the end-user function table; and
at least one of modifying, adding and deleting at least one of the synonym, the acronym and the category in the end-user function table in response to an input signal from the input unit.

9. The method of claim 1, wherein the function name comprises the name of each end-user function available for the mobile device.

10. The method of claim 1, wherein the performing of the search includes performing the search when receiving a given additional input signal after the search word is inputted.

11. A mobile device for supporting a search for end-user functions, the mobile device comprising:
an input unit configured to create a search word including at least one of letters and numerals;
a control unit configured to perform a search based on at least one of a synonym, an acronym and a category of function names by finding at least one of the synonym, the acronym and the category containing the search word; and
a display unit configured to output at least one of the function names as search results.

12. The mobile device of claim 11, wherein the display unit is further configured to output a screen interface suitable for supporting a function search mode.

13. The mobile device of claim 11, wherein the control unit is further configured to perform the search whenever each of the letters and numerals included in the search word is inputted.

14. The mobile device of claim 11, wherein the control unit is further configured to enter a function search mode based on the selection of at least one of a menu item and a hot key of the input unit.

15. The mobile device of claim 11, further comprising:
a memory unit configured to store an end-user function table that records the function names, and at least one of the category, the synonym, and the acronym of the function names.

16. The mobile device of claim 15, wherein the display unit is further configured to output a screen interface suitable for an update of the end-user function table, the screen interface allowing at least one of the synonym, acronym and category in the end-user function table to be at least one of modified, added and deleted in response to an input signal from the input unit.

17. The mobile device of claim 15, further comprising:
a radio frequency unit configured to establish a communication channel with an update server and to receive update information from the update server under the control of the control unit, the received information being used for an update of the end-user function table.

18. The mobile device of claim 11, wherein the function name comprises the name of each end-user function available for the mobile device.

19. The mobile device of claim 11, wherein the control unit is further configured to output a given message on the display unit when there is no search result in response to the search word.

20. The mobile device of claim 11, wherein the control unit is further configured to perform the search when receiving a given additional input signal after the search word is inputted.
